(19) United States
(12) Patent Application Publication
(10) Pub. No.: US 2022/0343350 A1
(43) Pub. Date: Oct. 27, 2022

(54) MARKET BASKET ANALYSIS FOR INFANT HYBRID TECHNOLOGY DETECTION

(71) Applicant: EMC IP Holding Company LLC, Hopkinton, MA (US)

(72) Inventors: Mohamed Abouzeid, Zayed (EG); Ahmed Osama, Cairo (EG); Amr Abdel Aziz, Cairo (EG); Marianne Toma, Cairo (EG); Stephen J. Todd, North Andover, MA (US); Osama Taha Mohamed, Cairo (EG); Yaseen Moussa, New Cairo (EG); Abdulrahman Diaa, Cairo (EG)

(21) Appl. No.: 17/237,400

(22) Filed: Apr. 22, 2021

(51) Int. Cl. G06Q 30/02; G06F 16/35; G06N 20/00

(52) U.S. Cl. CPC G06Q 30/0202; G06Q 30/0201; G06F 16/353; G06N 20/00

(57) ABSTRACT

One example method includes identifying emerging hybrid technologies. Datasets are data mined to identify transactions that are related to technology. Associations are generated based on the transactions and the associations are processed to identify emerging hybrid technologies from the transactions.

### RELATED APPLICATIONS

This application is related to application Ser. No. 17,160,782, filed Jan. 28, 2021 and entitled FORECASTING TECHNOLOGY PHASE USING UNSUPERVISED CLUSTERING WITH WARDLEY MAPS, which application is incorporated by reference in its entirety.

### FIELD OF THE INVENTION

Embodiments of the present invention generally relate to identifying technology trends. More particularly, at least some embodiments of the invention relate to systems, hardware, software, computer-readable media, and methods for detecting nascent technology including hybrid technologies.

### BACKGROUND

As companies look to the future, there is a need to make decisions regarding product development, technology investment, and the like. These decisions are significant and there is risk involved. Investing in the wrong technology, for example, can cost a company millions of dollars.

More specifically, technology is continually changing and evolving. Current technologies are being replaced by different and newer technologies. For example, current 4G technology has become commoditized and is in the process of being replaced with 5G technology. Within a few years, 5G technology will similarly be replaced.

One of the risks facing companies today is that the new technology that will replace existing technology is unknown. For this reason, companies try to make informed judgments regarding their investments in and the adoption of new technologies.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of a technology evolution cycle;

FIG. 2 discloses aspects of a technology prediction pipeline;

FIG. 3 discloses aspects of a classifier in a technology prediction pipeline;

FIG. 4 discloses aspects of a technology prediction pipeline that generates filtered transactions;

FIG. 5 discloses additional aspects of a technology prediction pipeline including an association engine;

FIG. 6 discloses aspects of associations and/or predictions generated by a technology prediction pipeline;

FIG. 7 discloses aspects of associations and/or predictions generated by a technology prediction pipeline;

FIG. 8 discloses aspects of a method for detecting or identifying genesis technologies; and

FIG. 9 discloses aspects of a computing device.

### DETAILED DESCRIPTION OF SOME EXAMPLE EMBODIMENTS

Embodiments of the present invention generally relate to identifying emerging technologies. More particularly, at least some embodiments of the invention relate to systems, hardware, software, computer-readable media, and methods for performing a market basket analysis (e.g., apriori algorithm) to detect or identify nascent or emerging technologies. More specifically, example embodiments of the invention predict, detect, or identify technologies that are most likely to emerge out of current mainstream technologies. Emerging technologies are identified using a data-driven approach and models to generate inferences or predictions regarding emerging technologies.

Many companies rely on technical experts in an attempt to forecast or predict technologies that will be trending in the future. However, these predictions are not always correct and mistakes can be costly. Embodiments of the invention improve the ability to identify emerging technologies, which reduces risk and exposure.

Embodiments of the invention generate models that are related to current technologies. These models explain current technologies such that predictions about emerging technologies can be generated by extrapolating from the models.

Embodiments of the invention are further configured to identify hybrid technologies. By way of example, a hybrid technology is a technology that is based on the inter-usage of two or more mature (e.g., commoditized) technologies. For example, blockchain technologies and machine learning are well understood technologies. One example of a hybrid technology is to determine how blockchain can be used to help secure machine learning. Hybrid technologies are often built on established paradigms, which facilitates technology adoption and which helps reduce costs.

Embodiments of the invention relate to performing an analysis (e.g., apriori algorithm or market basket analysis or data mining) on mature technologies. For example, a market based analysis is an example of data mining. Applying a market basket analysis to purchasing patterns, for example, can be used to identify associations such as which items are often purchased together in the same transaction.

Embodiments of the invention can perform data mining techniques to detect emerging technologies by, in one example, treating technology as transactions. For example, research papers (e.g., publications, patents, research documents, white papers) may each be considered a transaction and the key technologies described in those papers may be considered to be items in the transaction. The technologies can be mapped to the transaction such that the described technologies are items with respect to the transaction. This analysis allows rules or associations to be inferred that reflect the potential technology fusions that may result in nascent hybrid technologies.

Thus, embodiments of the invention predict the technologies that may emerge out of existing technologies. The predicted technologies may include hybrid technologies and represent technologies that are just beginning to emerge.

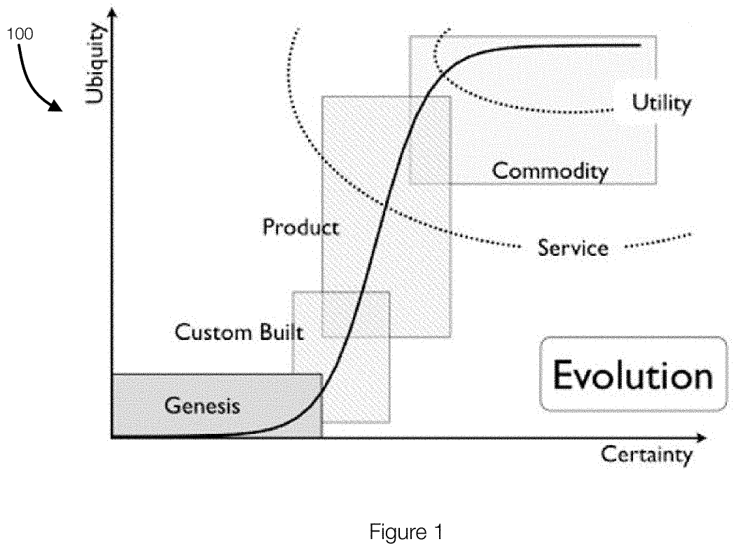

FIG. 1 discloses aspects of a technology evolution cycle. FIG. 1 illustrates a graph 100 (e.g., a Wardley Map) to illustrate the phases or states through which a technology passes. During the evolution cycle show in the graph 100, a technology starts as a genesis technology. In this phase or state, the genesis technology is being explored and researched. The technology then reaches the custom-built phase or state. In the custom-built phase, a few companies may be building customized products using the technology. These customized products are often expensive.

Next, a product phase or state is reached in which companies compete using the technology and many products may be available using or based on the technology. The commodity phase or state represents technology that is certain and ubiquitous. Technology in the commodity phase, or even in the product phase, is more widely known and is relatively less expensive.

New technologies often emerge out of commoditized technologies and enter the genesis phase. Thus, new technologies often have their genesis from technologies in the commodity or product phases. As previously stated for example, 4G technology started as a genesis technology and passed through the custom built, product, and commodity phases. The 5G technology appeared from this existing technology and is passing through the same technology evolution cycle illustrated in the graph 100.

Market basket analysis is an example of a statistical process that may be used to identify associations between items or products. For example, grocery purchasing data can be mined or processed to determine whether shoppers buy milk and bread at the same time. These associations or rules generated from the purchasing dataset are inferred by looking for combinations of items that occur together frequently in transactions. Market basket analysis focuses on the relationships between different items. Embodiments of the invention may perform a market basket analysis to find associations or association rules between different technologies. This generates insights or inferences or predictions to identify which technologies will emerge from technologies that are mature, including technologies in the product and/or commodity phases.

Embodiments of the invention relate to a technology prediction pipeline (pipeline) that is configured to identify nascent technologies, also referred to herein as emerging or genesis technologies. The pipeline may receive, as input, at least one dataset and output predictions. The input may include data related to mature technologies and the predictions may identify potentially emerging technologies.

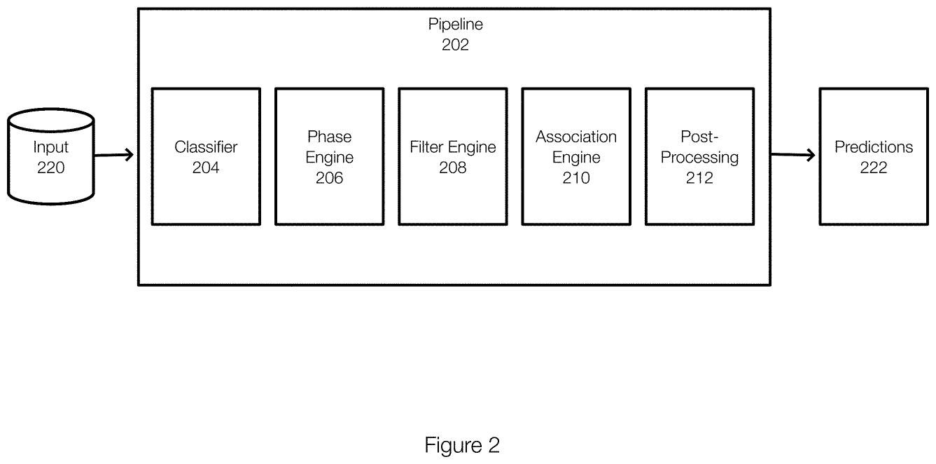

FIG. 2 discloses aspects of a technology detection pipeline configured to detect or identify emerging technologies. A pipeline 202 may receive an input 220 into a classifier 204. The input 220 may be dataset that includes transactions. For example, if the input 220 includes scientific papers, each paper may represent a transaction and the technologies described therein may represent items of the transaction. The classifier 204 may process the dataset to extract relevant terms. These terms may be processed using a Computer Science Ontology (CSO) classifier such that terminology is unified across the dataset. Thus, the classifier allows the dataset to be a presented, by way of example only, as a set of transactions where each transaction is associated with one or more items.

The phase engine 206 is configured to predict the phase of the technologies in the input 220. Thus, the phases (genesis, custom-built, product, commodity) of the transactions can be predicted or determined. The filter engine 208 may generate a filtered set of transactions that include only transactions associated with the product or commodity phase in one example.

The association engine 210 then determines associations or rules from the filtered transactions. Using metrics such as confidence, support, and lift, associations can be generated. The output of the association engine 210 may be post-processed 212. The predictions 222 output from the pipeline 202 may include these associations.

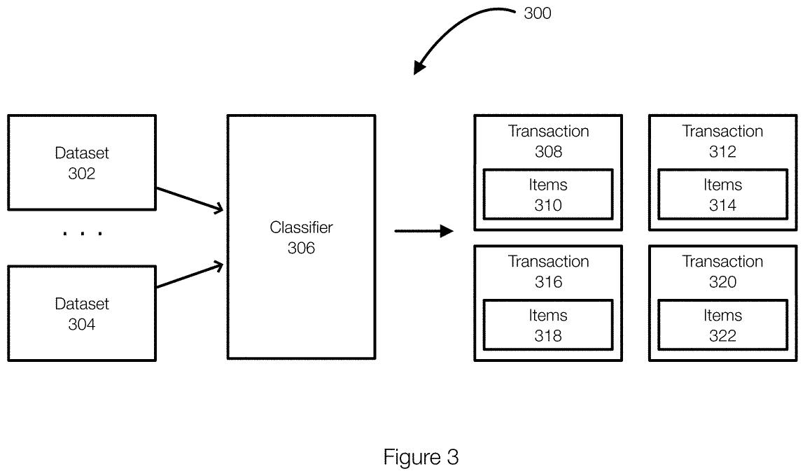

FIG. 3 illustrates a portion of a pipeline configured to predict nascent technologies. FIG. 3, more specifically, illustrates the classifier portion 300 of a pipeline such as the pipeline 202. The portion 300 includes a classifier 306 that receives one or more datasets, represented as dataset 302 and dataset 304, as input. The classifier 306 may extract terms from the datasets 302 and 304. By way of example only, the datasets 302 and 304 may be sets of documents or papers such as from an arXiv research dataset or Google Public Patents Dataset.

In one example, the classifier 306 may extract terms using a Computer Science Ontology (CSO) classifier. This allows the same terms or keywords to unify terminologies that may be employed in the datasets 302 and 304 and allows the terms or keywords to be unified across multiple datasets. The classifier 306 may map the terms to the contents (e.g., the documents and papers) of the datasets 302 and 304. This allows each individual content (each paper, patent, etc.) to be viewed as a transaction.

The classifier 306 may output transactions, represented by transactions 308, 312, 316, and 320. Each of the transactions 308, 312, 316, and 320 are associated, respectively, with items 310, 314, 318, and 322. The items 310, 314, 318, and 322 may be terms or keywords, for example.

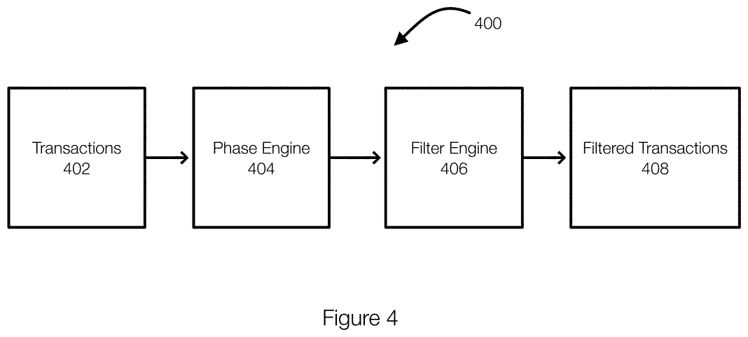

FIG. 4 discloses aspects of a pipeline including a phase engine and a filter engine. The portion 400 of the pipeline begins with the transactions 402 (e.g., transactions 308, 312, 316, and 320) output from the classifier 306. A phase engine 304 is configured to predict or determine the maturity of the transactions 302. For example, the phase engine 304 may determine, with respect to the map or graph 100 or other evolution cycle, the phase of each of the transactions 402. Thus, some of the transactions 402 may be determined or categorized to be in the genesis phase, while others may be determined categorized to be in the product phase or the commodity phase.

In this example, the filter engine 406 receives the categorized transactions from the phase engine 404. The filter engine 406 generates filtered transactions 408, which correspond to a set of the transactions 402 that are determined to be in the product or commodity phase.

In another example, each transaction may correspond to a technology rather than a specific document and the technology may be associated with keywords as well. This example is a metadata-based approach. In this example, a list of all terms that appears in all papers in the dataset related to a technology. This allows a technology to be viewed as a transaction and allows the terms related to that technology to be viewed as items of the transaction. This allows associations to be detected amongst more than the main technologies, using the key terms in the transactions. This allows, for example, associates to be generated between smaller technologies (e.g., the keywords) of the larger technologies. The transaction may be in the form of information on each technology. The items may be the keywords or terms mapped to each technology. In this example, a transaction combines information regarding the technology from all the academic papers and all the patents that were published annually (in other words a transaction for each technology for each year may be generated). Next, the pipeline focuses on passing the product and commodity technologies to the market basket analysis to produce the new set of genesis hybrid technologies that may emerge from the main technologies. This pipeline post processes the associations as previously discussed.

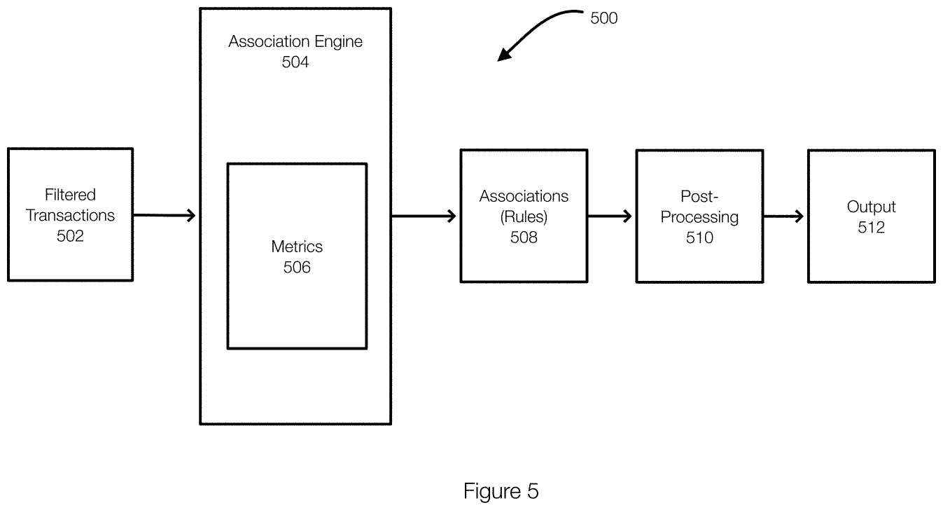

FIG. 5 further illustrates aspects of a pipeline for identifying nascent technologies. The portion 500 of a pipeline such as the pipeline 202 receives the filtered transactions 502 (i.e., the filtered transactions 408 in FIG. 4).

An association engine 504 generates or applies metrics 506 to the filtered transactions 502 to generate associations or rules 5089.

In one example, the metrics applied to the filtered transactions 502 include support, confidence, and lift. Support, in one example, essentially represents the fraction of the transactions that include two items A and B (e.g., terms) (although embodiments of the invention are not limited to considering only two terms. Confidence, in one example, represents how often the item B appears in the same transactions as the item A. Lift measures the percentage of increase in the confidence of having an item B in the transaction given that an item A was in the transaction.

Support, by way of example only, may be defined as follows:

$$Support ( A , B ) = \frac{\# ( A ⋂ B )}{Total}$$

In this example, #(A∩B) represents the number of transactions where A and B occur together and Total is the total number of transactions.

Confidence, by way of example only, may be defined as follows:

$${Confidence}_{B} ( A , B ) = \frac{\# ( A ⋂ B )}{\# ( A )}$$

In this example, #(A) denotes the number of transactions containing item A.

Lift, by way of example only, may be defined as follows:

$${Lift}_{B} ( A , B ) = \frac{{Confidence}_{B} ( A , B )}{\frac{\# ( B )}{Total}}$$

$$or$$

$${Lift}_{B} ( A , B ) = \frac{\frac{\# ( A ⋂ B )}{\# ( A )}}{\frac{\# ( B )}{Total}}$$

The association engine 504 can apply these metrics 506 to generate the associations or rules 508. The association engine 504 may perform an analysis using, for example, each combination of items or terms to generate the respective associations or rules 508. For example, if the items or terms across all transactions included items A, B, C, and D, then the metrics 506 may be generated for the following combinations of items: (A,B), (A,C), (A,D), (B,C), (B,D), and (C,D). The combinations could further be applied to triplets or the like in some embodiments.

The associations or rules 508 generated by the association engine 504 may be post-processed 510, for example by merging certain rules. For example, a word2vector model that extracts semantic meaning of terms in a vectorized format may be used to merge terms that are close together in meaning. This allows a larger association graph to be generated. Other models may be applied to the associations or rules 508.

In another example, some terms or items may be split to see how the associations 508 change. For example, a compound term such as “distributed machine learning” may be split prior to determining the associations or to compare the associations generated when the term is not split. Post-processing 510 results in the generation of stronger associations or rules.

The output 512 may include associations or rules that identify relationships between mature technologies that may identify technologies, by way of example only, that are in or that may enter the genesis phase. The associations or rules included in the output 512 may be ranked or processed to identify the most significant associations or rules.

As discussed herein, the pipeline is configured to extract data such as terms or keywords from the datasets being used. The classifier unifies the terminologies across all datasets and extracts a transaction. In one example, each paper/patent (or other document) is a transaction and each is a list of technologies (items) that are processed by the pipeline.

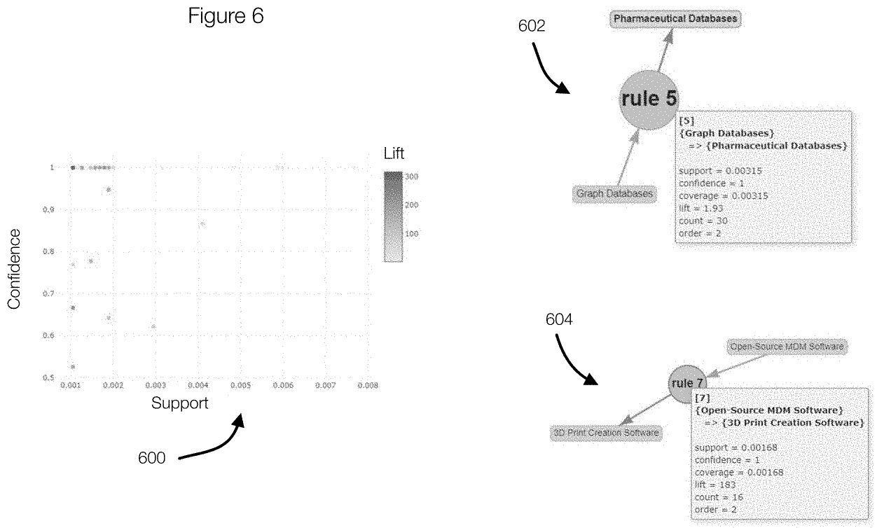

FIG. 6 discloses aspects applying a pipeline to a dataset. In one example, FIG. 6 illustrates an example of rules or associations generated from a dataset (e.g., arXiv dataset). The pipeline was applied using technology terms that were identified as or associated with the commodity or product phases. The pipeline generated rules, which are represented in the graph 500. The x axis is support, the y axis is confidence, and lift is represented by shading. As illustrated the graph 500, many of the rules have high confidence values and only rules with a confidence value of 0.5 or greater were extracted in this example. The rules generated by the pipeline also have low support values due to the large number of papers in the dataset. Large numbers of transactions lower the frequency of each rule that was extracted.

Once the rules were extracted, the rules could be filtered. The top rules were filtered by support and confidence. Using the filtered rules, associations 502 and 504, which may represent an emerging technology, can be identified.

The association 602 illustrates that graph databases were mentioned with pharmaceutical databases 30 times in the dataset. This indicates the emergence of a hybrid technology that uses graph technology with pharmaceutical data. The association 604 illustrates that there is a relationship between open source MDM software and 3D printing software. In the associations 602 and 604, the size of the circles represents the corresponding support.

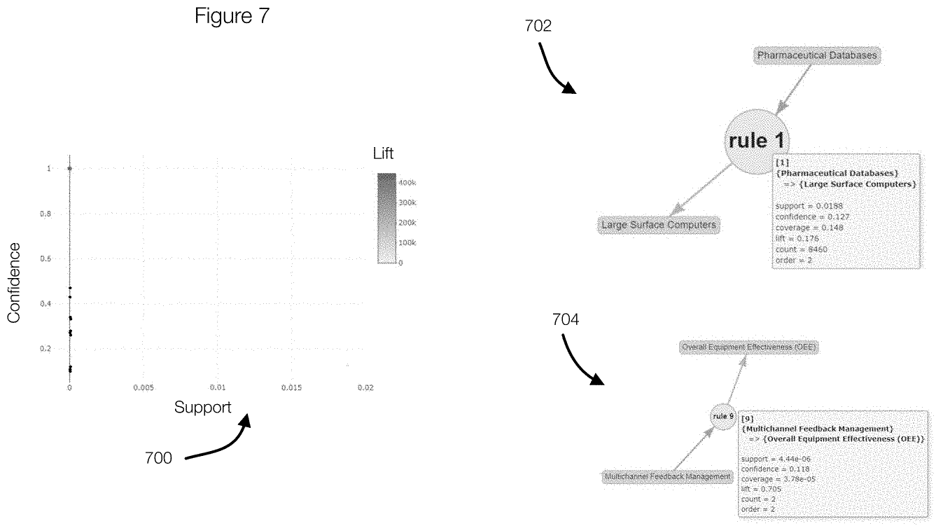

FIG. 7 discloses aspects of processing a dataset with a technology identification pipeline configured to identify genesis or nascent technologies. In FIG. 7, the dataset may be a set of patents for a particular year. The patents were filtered based on their determine phase such that the pipeline was applied to patents deemed to be in the product or commodity phase.

In this example, many of the confidence scores are low because the patents cover mature technologies, which is related to the time needed to obtain a patent. As a result, the frequency and diversity of the rules may be lowered. Further many of the rules have low lift values (illustrated as black dots for viewing purposes).

Example associations 702 and 704 were extracted or output by the pipeline. The association 702 is as association between pharmaceutical databases and large surface computers. The association 702 is similar to the association 602 generated from a different dataset. The association 702 may be a prerequisite to the emergence of a hybrid technology that uses graph technology and pharmaceutical data shown in FIG. 6.

The association 704 illustrates a relationship between overall equipment effectiveness (OEE) and multichannel feedback management. This relationship could be related to the nature of the dataset and/or based on a choice of using commodity and product labeled technologies.

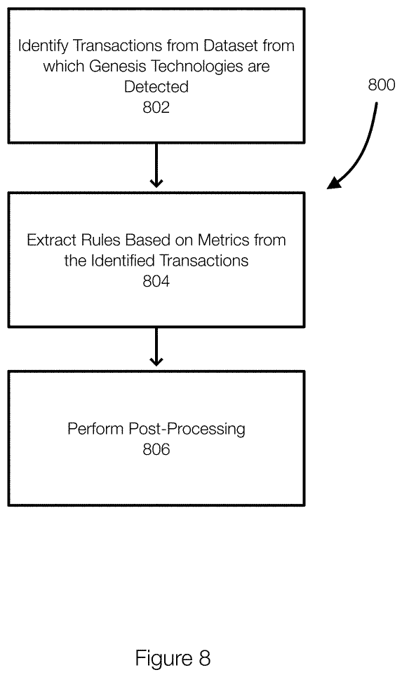

FIG. 8 discloses aspects of a method for identifying a genesis or nascent technology. The method 800 may begin by identifying 802 transactions (and items for each transaction) from a dataset. In one example, the method 800 may begin with a dataset that has been prepared for the pipeline. The dataset may only include transactions deemed to be in the product or commodity phases.

In another example, the dataset has not been prepared for the pipeline. Thus, one aspect of identifying transactions from the dataset is to prepare the dataset for further processing. Preparing the dataset may include selecting the dataset to be used. After selecting the dataset, items such as keywords, terms, groups of keywords, or the like may be identified from the dataset and the transactions can be classified. If more than one dataset is being used, the items may be normalized or unified across all datasets. The items of the transactions may include or be represented by technology terminologies.

In one example, a document may be a transaction and items may be keywords in the document. A document discussing graphing software and 3D printing may be deemed a transaction that is associated with or mapped to item A (graphing software) and item B (3D printing). In addition, identifying 802 transactions may also include identifying which transactions relate to technologies that are in the product or commodity phase of a technology evolution cycle. Thus, the transactions may be filtered such that product or commodity transactions are identified. This allows genesis technologies to be detected from mature technologies.

Once a filtered dataset is generated and appropriate transactions are identified 802, rules or associations are extracted 804 from the filtered transactions. This may include determining support, confidence, and lift metrics. An analysis of these metrics results in the associations, such as illustrated in FIGS. 6 and 7. The associations or rules may be post-processed 806 to identify additional trends. This may include applying models, splitting compounded technology terms, or the like. The outputs of the method 800 may represent emerging technologies that have been determined in a data driven manner.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, detection or prediction operations.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more. VMDK files (VM hard disks) for example. Embodiments of the invention may also include or relate to containers or containerized environments.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted with respect to the example method of Figure(s) XX that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Following are some further example embodiments of the invention. These are presented only by way of example and are not intended to limit the scope of the invention in any way.

Embodiment 1. A method, comprising: receiving a transactions, wherein each of the transactions are associated with one or more items and wherein each of the transactions is associated with a technology, generating metrics from the transactions;

determining associations from the metrics, wherein the associations identify hybrid technologies, and outputting predictions, the predictions including at least some of the hybrid technologies, wherein each of the hybrid technologies is associated with at least two of the transactions.

Embodiment 2. The method of embodiment 1, further comprising receiving, as input, a dataset that includes the transactions.

Embodiment 3. The method of embodiment 1 and/or 2, further comprising: receiving, as input, a dataset, processing the dataset to extract terms, wherein each term is associated with one of the technologies, and classifying the extracted terms such that the terms are unified across the dataset.

Embodiment 4. The method of embodiment 1, 2, and/or 3, wherein the dataset includes a plurality of different datasets.

Embodiment 5. The method of embodiment 1, 2, 3, and/or 4, further comprising determining a phase for each of the transactions, wherein each phase is one of a genesis phase, a custom-built phase, a product phase, or a commodity phase.

Embodiment 6. The method of embodiment 1, 2, 3, 4, and/or 5, further comprising filtering the transactions that are in the product phase or the commodity phase into filtered transactions.

Embodiment 7. The method of embodiment 1, 2, 3, 4, 5, and/or 6, wherein the metrics are generated from the filtered transactions.

Embodiment 8. The method of embodiment 1, 2, 3, 4, 5, 6, and/or 7, wherein the metrics are generated by generating a lift metric, a confidence metric, and a support metric, wherein the extracted transactions are above at least one of a lift threshold, a confidence threshold, and/or a support threshold.

Embodiment 9. The method of embodiment 1, 2, 3, 4, 5, 6, 7, and/or 8, further comprising processing the predictions by merging at least some of the associations using one or more models.

Embodiment 10. The method of embodiment 1, 2, 3, 4, 5, 6, 7, 8, and/or 9, wherein the models include one or more of a splitting compounded technology model and a word to vector model.

Embodiment 11. A method for performing any of the operations, methods, or processes, or any portion of any of these or any combination thereof, disclosed herein.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

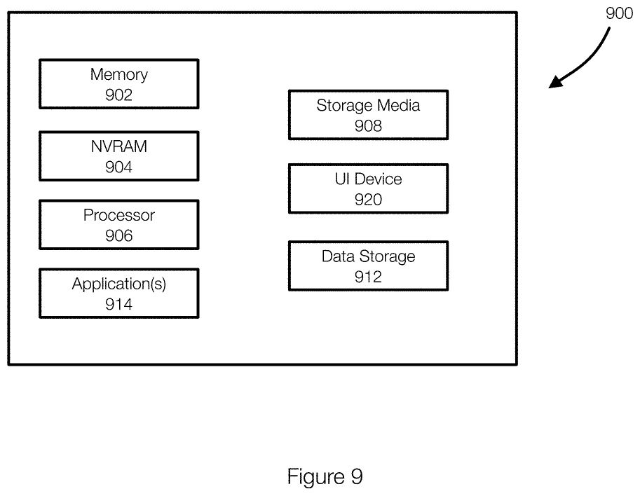

With reference briefly now to FIG. 9, any one or more of the entities disclosed, or implied, by in the Figures and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving transactions, wherein each of the transactions are associated with one or more items and wherein each of the transactions is associated with a technology;
generating metrics from the transactions;
determining associations from the metrics, wherein the associations identify hybrid technologies; and
outputting predictions, the predictions including at least some of the hybrid technologies, wherein each of the hybrid technologies is associated with at least two of the transactions.

2. The method of claim 1, further comprising receiving, as input, a dataset that includes the transactions.

3. The method of claim 1, further comprising:
receiving, as input, a dataset;
processing the dataset to extract terms, wherein each term is associated with one of the technologies; and
classifying the extracted terms such that the terms are unified across the dataset.

4. The method of claim 3, wherein the dataset includes a plurality of different datasets.

5. The method of claim 3, further comprising determining a phase for each of the transactions, wherein each phase is one of a genesis phase, a custom-built phase, a product phase, or a commodity phase.

6. The method of claim 5, further comprising filtering the transactions that are in the product phase or the commodity phase into filtered transactions.

7. The method of claim 6, wherein the metrics are generated from the filtered transactions.

8. The method of claim 7, wherein the metrics are generated by generating a lift metric, a confidence metric, and a support metric, wherein the extracted transactions are above at least one of a lift threshold, a confidence threshold, and/or a support threshold.

9. The method of claim 1, further comprising processing the predictions by merging at least some of the associations using one or more models.

10. The method of claim 9, wherein the models include one or more of a splitting compounded technology model and a word to vector model.

11. A non-transitory storage medium having stored therein instructions that are executable by one or more hardware processors to perform operations comprising:
receiving a transactions, wherein each of the transactions are associated with one or more items and wherein each of the transactions is associated with a technology;
generating metrics from the transactions;
determining associations from the metrics, wherein the associations identify hybrid technologies; and
outputting predictions, the predictions including at least some of the hybrid technologies, wherein each of the hybrid technologies is associated with at least two of the transactions.

12. The non-transitory storage medium of claim 11, further comprising receiving, as input, a dataset that includes the transactions.

13. The non-transitory storage medium of claim 11, further comprising:
receiving, as input, a dataset;
processing the dataset to extract terms, wherein each term is associated with one of the technologies; and
classifying the extracted terms such that the terms are unified across the dataset.

14. The non-transitory storage medium of claim 13, wherein the dataset includes a plurality of different datasets.

15. The non-transitory storage medium of claim 13, further comprising determining a phase for each of the transactions, wherein each phase is one of a genesis phase, a custom-built phase, a product phase, or a commodity phase.

16. The non-transitory storage medium of claim 15, further comprising filtering the transactions that are in the product phase or the commodity phase into filtered transactions.

17. The non-transitory storage medium of claim 16, wherein the metrics are generated from the filtered transactions.

18. The non-transitory storage medium of claim 17, wherein the metrics are generated by generating a lift metric, a confidence metric, and a support metric, wherein the extracted transactions are above at least one of a lift threshold, a confidence threshold, and/or a support threshold.

19. The non-transitory storage medium of claim 11, further comprising processing the predictions by merging at least some of the associations using one or more models.

20. The non-transitory storage medium of claim 19, wherein the models include one or more of a splitting compounded technology model and a word to vector model.
